(19) United States
(12) Patent Application Publication
(10) Pub. No.: US 2006/0217874 A1
(43) Pub. Date: Sep. 28, 2006

(54) Controller device of traffic signal equipment

(75) Inventors: Shinya Ueda, Osaka (JP); Shinji Togawa, Osaka (JP); Takao Matsuda, Osaka (JP); Mitsunori Yanagihara, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/166,121

(22) Filed: Jun. 27, 2005

(30) Foreign Application Priority Data
Mar. 23, 2005 (JP) 2005-084946

(51) Int. Cl. G08G 1/00

(52) U.S. Cl. 701/117; 701/211

(57) ABSTRACT

A controller device, after switching a traffic signal displayed on traffic signal equipment from a cross inhibition signal to a non cross inhibition signal, makes the traffic signal equipment display the non cross inhibition signal during a second time period before a second set time passes after a first time period ends to switch from the non cross inhibition signal to the cross inhibition signal responding to end of the second time period, if a detection signal indicating a target person of extension is received from a traverser detecting device during the first time period before a first set time passes after switching from the cross inhibition signal to the non cross inhibition signal. If no detection signal is received during the first time period, the controller device switches from the non cross inhibition signal to the cross inhibition signal responding to end of the first time period.

### BACKGROUND OF THE INVENTION

1. Field of the Invention

The present invention relates to a controller device for controlling traffic signal equipment that is installed on a road and has a characteristic in signal control for pedestrians.

2. Description of the Prior Art

Recently, traffic accidents of elderly people or handicapped people have become social problems. It has become important more and more to secure traffic safety of elderly people as a population ratio of elderly people increases. For this reason, control of the traffic signal equipment at crosswalks is being improved.

In general, traffic signal equipment has a function to display a first traffic signal (a red signal) that indicates stop, a second traffic signal (a green signal) that indicates go and a third traffic signal (a yellow signal or a blinking green signal) that warns that the signal will change to the first traffic signal soon. The traffic signal equipment is usually controlled so as to switch among these three traffic signals at a predetermined time interval.

It is commonly in operation that the traffic signal equipment changes the time interval for switching the signals in accordance with a change in a traffic situation. For example, traffic congestion in an intersection of plural roads may be relieved by temporarily increasing a time period for moving in a road having heavy traffic in accordance with an output signal from a sensor device for detecting vehicles.

It has also been proposed to control switching of signals for pedestrians. Japanese unexamined patent publications No. 2002-279584 and No. 2004-302648 disclose traffic signal systems that change a time period for switching signals automatically by detecting pedestrians.

The traffic signal systems proposed in the prior arts include communication terminals carried by pedestrians and traffic signal equipment having a wireless communication function. The communication terminal transmits a predetermined radio signal so as to inform the traffic signal equipment of the pedestrian's presence within the crosswalk or in proximity to the same. The traffic signal equipment recognizes presence of a pedestrian who is walking the crosswalk by receiving the radio signal and continues to display the traffic signal that indicates go until the pedestrian finishes walking the crosswalk. According to this traffic signal system, the traffic signal does not switch from a green signal to a red signal during the pedestrian is walking the crosswalk. Therefore, even elderly people or handicapped people who walk relatively slowly can cross the road safely. There is little possibility of dangerous situation where such people are left within a crosswalk. In addition, it is not necessary for pedestrians to do a certain operation for change (e.g., pressing a button) since the time period for switching signals is changed automatically.

In the conventional traffic signal system, it is possible that a state lasts long without switching signals for ending the display of the traffic signal to go walking (the green signal). In other words, it is possible that the state where vehicles are restricted to go lasts long. Such a state can be generated, for example, when a pedestrian who carries a predetermined communication terminal (a target person of extension) is walking across the road, another target person of extension starts walking across the road, followed by other plural target persons of extension continuously. The state may also be generated when a pedestrian who starts walking the crosswalk and gets out of the crosswalk during the walking or comes back after entering the crosswalk so that the traffic signal equipment can not determine whether the pedestrian has finished walking along the crosswalk or not. For the latter situation, there is a countermeasure of checking a position of the pedestrian correctly. In order to check the position of the pedestrian, however, position detectors are required to be placed all over the crosswalk with a lot of cost.

### SUMMARY OF THE INVENTION

An object of the present invention is to realize a traffic signal system that can switch traffic signals at an appropriate time interval so as to have a balance between pedestrian's safety in walking across a road and vehicles' smooth traffic along the road.

The controller device of traffic signal equipment according to the present invention monitors an input signal from a traverser detecting device after switching a traffic signal displayed on the traffic signal equipment from a cross inhibition signal to a non cross inhibition signal. If a detection signal that indicates a target person of extension is received from the traverser detecting device during a first time period before a first set time passes after switching from the cross inhibition signal to the non cross inhibition signal, the non cross inhibition signal is displayed on the traffic signal equipment during a second time period before a second set time passes after the first time period ends, and the traffic signal displayed on the traffic signal equipment is switched from the non cross inhibition signal to the cross inhibition signal responding to end of the second time period. If the detection signal is not received from the traverser detecting device during the first time period, the traffic signal displayed on the traffic signal equipment is switched from the non cross inhibition signal to the cross inhibition signal responding to end of the first time period.

The non cross inhibition signal is a signal that is not the cross inhibition signal among plural traffic signals that are displayed alternately or in a prescribed order. Therefore, in displaying a first signal that indicates a cross inhibition period, a second signal that indicates a crossable period and a third signal that indicates that the cross inhibition period will come soon, the second signal and the third signal correspond to the non cross inhibition signal while the first signal corresponds to the cross inhibition signal. In displaying the first signal and the second signal alternately, the second signal corresponds to the non cross inhibition signal.

When the traverser detecting device detects crossing of the target person of extension during the first time period while the non cross inhibition signal is displayed, the controller device that received the notice elongates the display period of the non cross inhibition signal from the end of the first time period until the second set time passes. The extension of the non cross inhibition period enables an elderly people or a handicapped person who cannot walk fast to cross a road in good time. In particular, the extension of the non cross inhibition period is useful in a wide road having a long crossing distance. The target person of extension is a pedestrian who needs the extension of the non cross inhibition period. On the other hand, the extension of the non cross inhibition period is restricted by the second set time, so that the traffic of vehicles is not interrupted so long.

A more preferable controller device stores level information contained in the detection signal responding to the reception of the detection signal from the traverser detecting device in the first time period, and then time corresponding to the level information is set as the second set time. A still more preferable controller device sets the longest time period among plural time periods corresponding to level information of the plural detection signals as the second set time if plural detection signals that respectively indicate plural target persons of extension are received from the traverser detecting device during the first time period. The time setting corresponding to the level information has an effect of preventing a wasteful extension of the display of the non cross inhibition signal.

Another more preferable controller device stores identification information of the target person of extension and the level information contained in the detection signal in connection with each other responding to the reception of the detection signal from the traverser detecting device during the first time period. If a detection signal containing the identification information of the target person of extension that is stored at the time is received from the traverser detecting device during the first time period, the stored information about the identification information of the target person of extension and the corresponding level information is erased. After the first time period, a time period corresponding to the level information stored at the time is set as the second set time. This controller device has an effect of preventing start of elongating the non cross inhibition signal after the target person of extension finishes the crossing.

According to the present invention, it is possible to realize a traffic signal system that can switch traffic signals at an appropriate time interval so as to have a balance between pedestrian's safety in walking across a road and vehicles' smooth traffic along the road.

### BRIEF DESCRIPTION OF THE DRAWINGS

FIG. 1 is a diagram showing a structure of a traffic signal system according to the present invention.

FIGS. 2(A)-2(G) are diagrams showing a general outline of switching signals according to the present invention.

FIG. 3 is a diagram showing a functional structure of a controller device.

FIG. 4 is a diagram showing a control sequence.

FIG. 5 is a flowchart showing a general outline of an operation of a switching time control portion.

FIG. 6 is a flowchart showing a table setting process.

FIG. 7 is a flowchart showing a timer setting process.

FIG. 8 is a flowchart showing a warning process.

FIG. 9 is a diagram showing a variation of a table.

FIG. 10 is a diagram showing an example of setting an extra time using the table shown in FIG. 9.

FIG. 11 is a diagram showing a variation of setting a reader device.

### DESCRIPTION OF THE PREFERRED EMBODIMENTS

Hereinafter, the present invention will be explained more in detail with reference to embodiments and drawings.

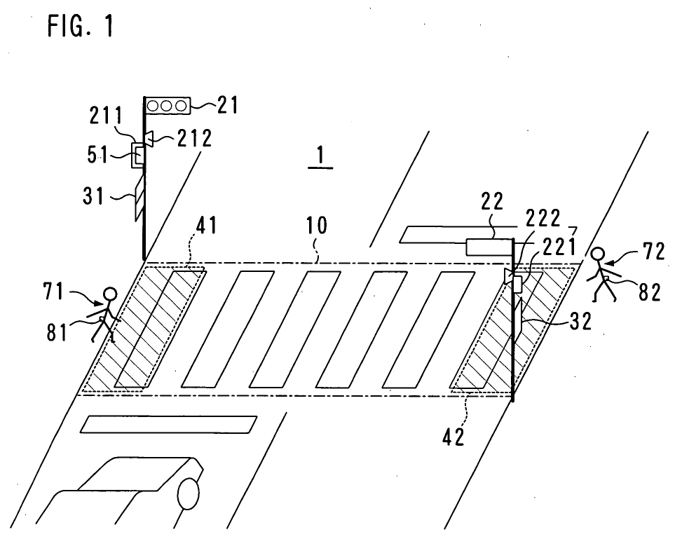

FIG. 1 shows a structure of a traffic signal system according to the present invention. The traffic signal system 1 exemplified in FIG. 1 is a system for controlling traffic signals in a crosswalk 10.

The traffic signal system 1 is equipped with traffic signal equipment 21 and 22 for vehicles, traffic signal equipment 31 and 32 for pedestrians, reader devices 41 and 42 as traverser detecting devices, a controller device 51, and transmitting devices 81 and 82.

Each piece of the traffic signal equipment 21 and 22 includes three types of indicator lights having different colors for displaying three types of traffic signals. A control box 211 and an audio output device 212 are attached to a mast for supporting the indicator lights of the traffic signal equipment 21. In the same manner, a control box 221 and an audio output device 222 are attached to a mast of the traffic signal equipment 22. Each of the control boxes 211 and 221 houses a controller for controlling corresponding indicator lights and the audio output device 212 or 222. The audio output devices 212 and 222 are used for an audio assist for visually impaired people or for caution during an extra period that is unique to the present invention.

Each piece of the traffic signal equipment 31 and 32 has two types of indicator lights having different light emission colors and is capable of displaying three types of traffic signals including a signal for blinking the indicator light. The traffic signal equipment 31 and 32 is disposed separately from each other at one end and the other of the crosswalk 10 in the crossing direction (right and left direction in FIG. 1), and each piece of the equipment displays the traffic signal toward the opposite side. In addition, the traffic signal equipment 31 and 32 is fixed to the masts of the traffic signal equipment 21 and 22 respectively, and the controllers of the traffic signal equipment 31 and 32 are housed in the control boxes 211 and 221, respectively.

The reader device 41 is disposed at one end of the crosswalk 10 in the crossing direction (right and left direction in FIG. 1), and the reader device 42 is disposed at the other end of the crosswalk 10. In this example, these reader devices 41 and 42 are antenna units for transmitting and receiving radio signals to and from radio frequency identification (RFID) tags, and they are embedded in the crosswalk 10. Each of sensing areas of the reader devices 41 and 42 is a band-like area that extends in the direction perpendicular to the crossing direction and has a width of approximately one meter and a length that is substantially the same as the width of the crosswalk 10. Although it is preferable that they are embedded in the road for reliability of their operation and easiness of their installation, it is also possible to place the reader devices 41 and 42 on the ground surface.

The controller device 51 includes a processor that executes a control program and peripheral devices that are necessary for executing the program, and it controls the traffic signal equipment 21, 22, 31 and 32 in accordance with output signals of the reader devices 41 and 42 as being described later. Although it is possible to control the traffic signal equipment 21, 22, 31 and 32 separately, the traffic signal equipment 21 and 22 for vehicles is controlled as a common control, while the traffic signal equipment 31 and 32 is controlled as a common control, in this example. In FIG.1, the controller device 51 is housed in the control box 211 of the traffic signal equipment 21. However, it is not always necessary to install the controller device 51 in the vicinity of the crosswalk 10. It is possible, for example, to install the controller device 51 in a traffic control center that controls local transportation so that the controller device 51 controls the traffic signal equipment 21, 22, 31 and 32 by remote control.

The transmitting devices 81 and 82 are small and light-weight devices carried by target persons of extension 71 and 72 who are specific pedestrians, and the transmitting devices 81 and 82 transmit the radio signals that are received by the reader devices 41 and 42. Each of the radio signals includes identification information (ID) for determining the target person of extension 71 or 72 individually and level information (Level) that indicates a class of walking ability. In this example, a preferred example of the transmitting devices 81 and 82 is an RFID tag (or an IC tag). An RFID tag without a battery is maintenance free and inexpensive. An RF tag can be attached to the target persons of extension 71 and 72 directly. Otherwise, it can be embedded in or attached to clothes or goods that are carried by the target persons of extension 71 and 72 (such as shoes, a walking stick or a cap that are carried usually, a notebook, a card or other certificates). However, it is not limited to the RFID tag, but it can be any portable device storing information that can be read externally in a noncontact manner.

In the traffic signal system 1 including the elements described above, it is supposed that the target person of extension 71 who carries the transmitting device 81 walks the crosswalk 10 from one end thereof (the left end in FIG. 1) to the other end (the right end in FIG. 1). The information stored in the transmitting device 81 is transmitted to the controller device 51 via the reader device 41 when the target person of extension 71 walks above the reader device 41 (at a timing of starting to cross). Then, the information stored in the transmitting device 81 is transmitted to the controller device 51 again via the reader device 42 this time when the target person of extension 71 walks above the reader device 42 at the right end side (at a timing of completing to cross). In addition, if the target person of extension 71 stops to crossing after passing above the reader device 41 and returns back, the information is transmitted to the controller device 51 again when the target person of extension 71 walks above the reader device 41. The information is transmitted to the controller device 51 via the reader device 42 and the reader device 41 when the target person of extension 71 walks from the right end to the left end.

Thus, the target person of extension 71 is detected at least twice regardless of which end the target person of extension 71 starts to cross from. Considering the case where the target person of extension 71 repeats going forward and backward, it can be regarded that the target person of extension 71 is still walking in the crosswalk 10 if the number of the detection is an odd number while target person of extension 71 has finished or stopped crossing if the number of the detection is an even number.

In the present invention, it is not always necessary to detect the finish of the crossing. However, it is possible to eliminate a waste extension of time for crossing when the target person of extension has finished the crossing, by detecting the finish of the crossing so as to decide whether the extension of the signal is necessary or not.

Note that there is no limitation of the number of the target persons of extension although there are two target persons of extension 71 and 72 in FIG. 1. In addition, pedestrians other than the target person of extension can naturally walk the crosswalk 10. The pedestrians may include a user of a wheelchair.

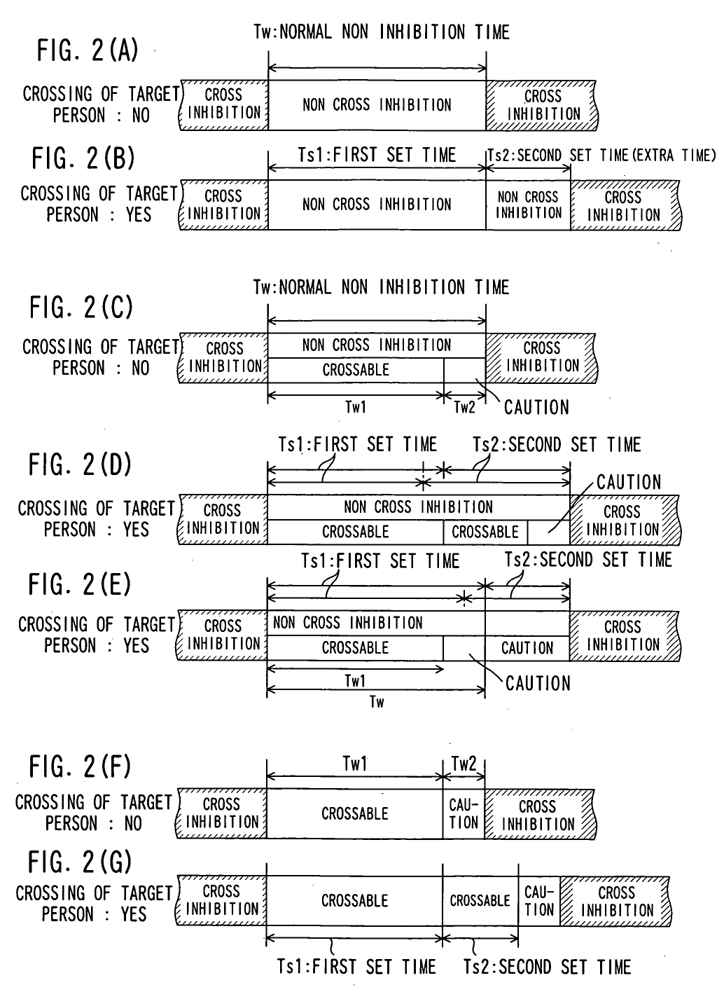

FIGS. 2(A)-2(G) are diagrams showing a general outline of switching signals according to the present invention.

Basically, as shown in FIGS. 2(A) and 2(B), time for non cross inhibition is expanded only when a target person of extension crosses.

If the target person of extension does not cross as shown in FIG. 2(A), the “cross inhibition” is switched to “non cross inhibition”, and then the “non cross inhibition” is switched to the “cross inhibition” when a normal non inhibition time Tw has passed. The normal non inhibition time Tw is a prescribed time that is determined in accordance with a prediction of traffic. However, it is not necessary that the normal non inhibition time Tw be fixed. The normal non inhibition time Tw can be changed for each time zone or in accordance with actual measurement of traffic if necessary.

As shown in FIG. 2(B), when the target person of extension crosses, the “non cross inhibition” is maintained after switching from the “cross inhibition” to the “non cross inhibition” until a first set time Ts1 having the same length as the normal non inhibition time Tw passes and further a second set time Ts2 passes. The second set time Ts2 is the extra time.

Such signal switching shown in FIGS. 2(A) and 2(B) are adapted to both an alternate display of two signals and a rotation display of three signals.

FIGS. 2(C), 2(D) and 2(E) show application examples of the present invention in the rotation display of three signals.

As shown in FIG. 2(C), if the target person of extension does not cross, the signal is switched from the “cross inhibition” to “crossable”. When a prescribed time Tw1 passes, the signal is switched from the “crossable” to “caution”. Furthermore, when a prescribed time Tw2 passes, the signal is switched from the “caution” to the “cross inhibition”. The signal “caution” means to display an advance signal warning that the signal will be switched to “cross inhibition” soon (it has various names such as a yellow signal or a warning signal). In the control of the traffic signal equipment 31 and 32 having two indicator lights, the “caution” is a blinking display.

As shown in FIGS. 2(D) and 2(E), signal switching when the target person of extension crosses includes two forms depending on how to determine the length of the first set time Ts1.

As shown in FIG. 2(D), the length of the first set time Ts1 is equal to or shorter than that of the prescribed time Tw1 (0<Ts1<Tw1). According to this time setting, the “crossable” period is elongated since it is “crossable” period when the first set time Ts1 passes. However, it is possible to set the “caution” period longer than the prescribed time Tw2 within the range where the sum of “crossable” extra time and the “caution” period does not exceed the second set time Ts2. In this case, a ratio between the “crossable” period and the “caution” period in the second set time Ts2 can be any value.

As shown in FIG. 2(E), the length of the first set time Ts1 is equal to that of the normal non inhibition time Tw, or it is longer than the prescribed time Tw1 and shorter than the normal non inhibition time Tw (Tw1<Ts1≦Tw). According to this time setting, the “caution” period is elongated since it is “caution” period when the first set time Ts1 passes.

FIGS. 2(F) and 2(G) also show application examples of the present invention in the rotation display of three signals. In this example, the length of the first set time Ts1 is equal to that of the normal non inhibition time Tw. This is not based on elongating the non cross inhibition period but is based on elongating the “crossable” period.

It is possible to elongate the “caution” period in FIG. 2(G), and in this case the extra time of “caution” period is not included in the second set time Ts1. The second set time Ts1 should be limited to the extra time of the “crossable” period.

Hereinafter, the operation of the controller device 51 will be described in detail on the precondition of the rotation display of three signals. In the description, some expressions are referred to as follows for convenience.

The traffic signal displayed on the traffic signal equipment 21 and 22 for vehicles is referred to as a “signal for vehicles.”

The traffic signal displayed on the traffic signal equipment 31 and 32 for pedestrians is referred to as a “signal for pedestrians.”

The first signal indicating inhibition of go of the signal for vehicles or the signal for pedestrians is referred to as a “red signal.”

The second signal indicating permission to go of the signal for vehicles or the signal for pedestrians is referred to as a “green signal.”

The third signal warning the inhibition of go of the signal for vehicles is referred to as a “yellow signal.”

The third signal warning the inhibition of go of the signal for pedestrians is referred to as a “blinking green signal.”

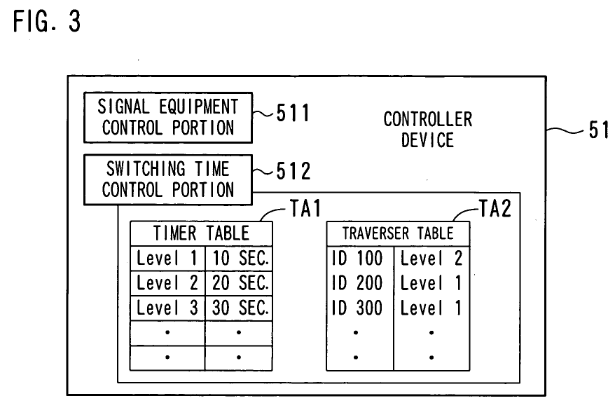

FIG. 3 shows a functional structure of the controller device.

The controller device 51 includes a signal equipment control portion 511 and a switching time control portion 512. The signal equipment control portion 511 instructs the traffic signal equipment 21, 22, 31 and 33 to switch signals. The switching time control portion 512 changes time periods of switching signals by using a timer table TA1 and a traverser table TA2.

The timer table TA1, which are data for organizing relationships between the level information (Level) indicating one of classes of walking speed divided into plural steps and extra time that is determined for each class, is stored in a non-volatile memory. In this example, Level 1 corresponds to 10 seconds, Level 2 corresponds to 20 seconds, and Level 3 corresponds to 30 seconds. Here, the extra time is decided in accordance with a time required to cross depending on the length of the crosswalk 10 and the walking speed, the normal non inhibition time Tw and other factors. In this case, traffic situations that are unique to the crosswalk 10 may also be considered. In other words, the extra time is customized in accordance with the road to which the traffic signal system 1 is applied.

The traverser table TA2 is a working table for executing the program, and it stores identification information (ID) and level information received from the reader devices 41 and 42. Note that if a form of assigning different ID codes to different Levels is adopted, storing the ID code means storing the identification information and the Level information.

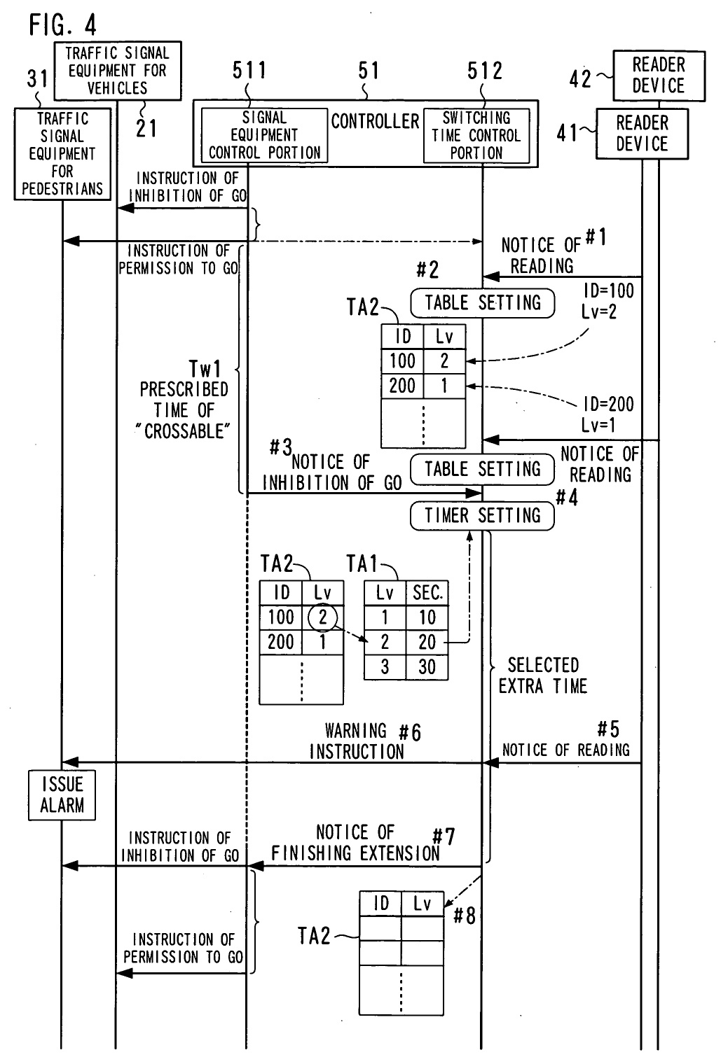

FIG. 4 shows a control sequence. As described above, the operations of the traffic signal equipment 21 and 22 are the same, and the operations of the traffic signal equipment 31 and 32 are the same. Therefore, the traffic signal equipment 21 and 31 is shown in FIG. 4 as a representative for vehicles and a representative for pedestrians.

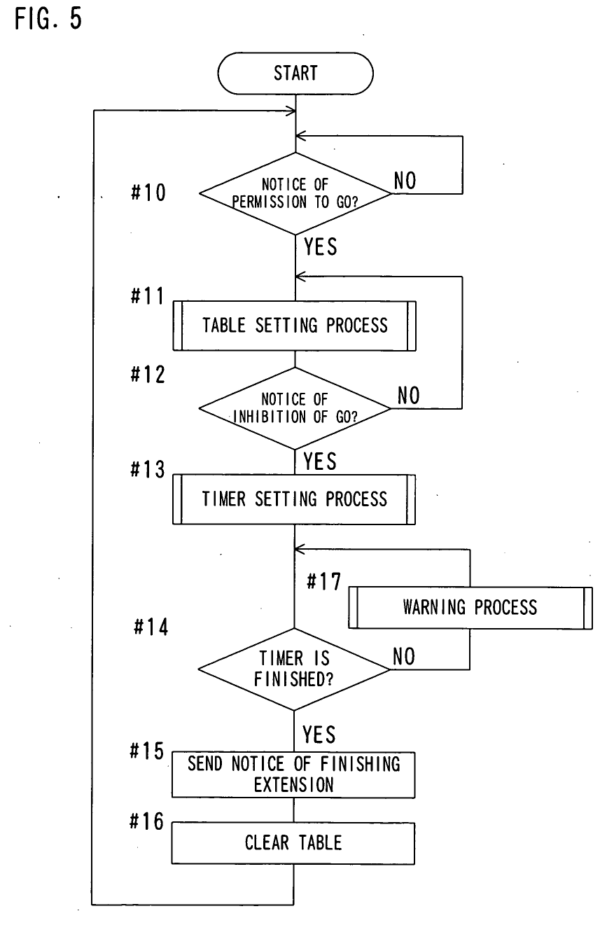

The signal equipment control portion 511 gives an instruction of inhibition of go to the traffic signal equipment 21 and a little later gives an instruction of permission to go to the traffic signal equipment 31. Responding to these instructions, the signal for vehicles switches from the yellow signal to the red signal, while the signal for pedestrians switches from the red signal to the green signal. In addition, responding to the instruction of permission to go to the traffic equipment 31, the switching time control portion 512 performs a sequence of processes shown in the flowchart of FIGS. 5-8.

When the signal for pedestrians is the green signal, the switching time control portion 512 monitors the input from the reader devices 41 and 42.

For example, when the target person of extension starts to cross the road from the side where the reader device 41 is placed to the opposite side, the identification information and the level information are read from the transmitting device carried by the target person of extension, and the information set is transferred from the reader device 41 to the switching time control portion 512 as a notice of reading (step #1 in FIG. 4). As illustrated, the identification information (ID) is denoted by reference numeral 100, and the level information (Lv) is denoted by reference numeral 2.

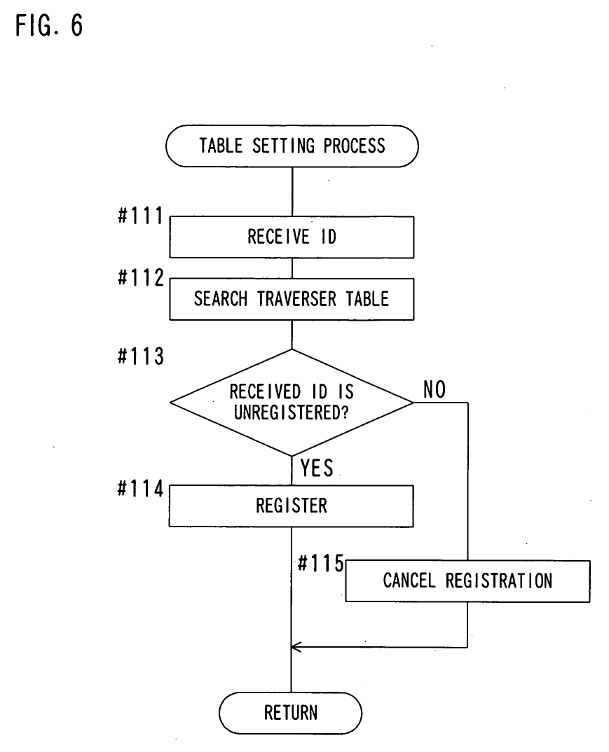

The switching time control portion 512 responds to the notice of reading and performs the table setting process (step #2 in FIG. 4, step #11 in FIG. 5). First, the switching time control portion 512 fetch the information about the notice of reading and searches the traverser table TA2 (steps #111 and #112 in FIG. 6). If the received ID is not registered, the ID and the level information are registered in the traverser table TA2 (steps #113 and #114 in FIG. 6). If the received ID is already registered, the registered ID and level information are deleted. Thus, it is considered that the target person of extension having the ID has finished crossing or stopped and returned, so that the registration is canceled (step #115 in FIG. 6). After that, the table setting process is performed every time when the notice of reading is received during the period while the signal for pedestrians is the green signal. In the example shown in FIG. 4, ID=200 and Lv=1, which were entered from the reader device 42, are registered.

On the other hand, when the time Tw1 passes after the signal for pedestrians is switched from the red signal to the green signal, the signal equipment control portion 511 sends the notice of inhibition of go promptly to the switching time control portion 512 (step #3 in FIG. 4). Here, the time Tw1 is the prescribed time of the permission to go shown in FIG. 2(F) and corresponds to the first set time of the present invention.

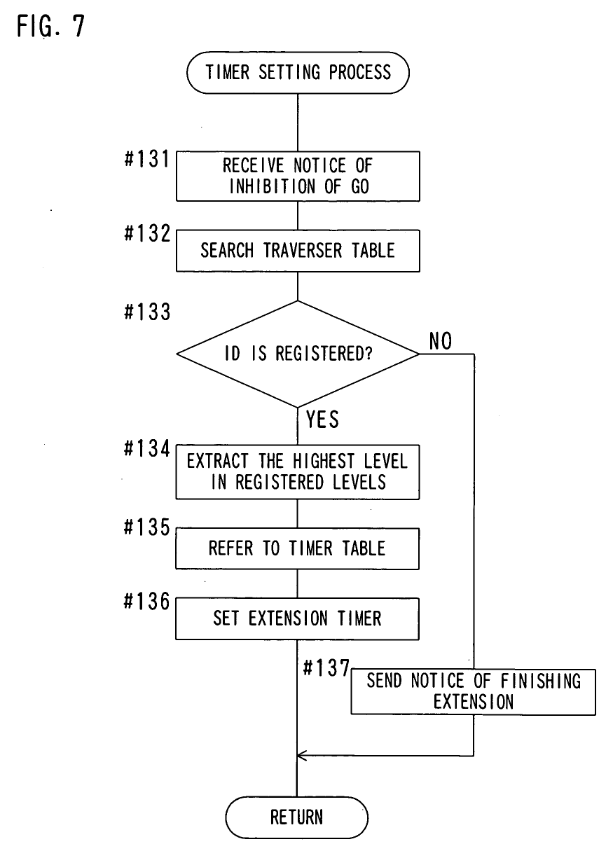

Receiving the notice of inhibition of go, the switching time control portion 512 performs the timer setting process (step #4 in FIG. 4, steps #12 and #13 in FIG. 5). The switching time control portion 512 searches the traverser table TA2 (steps #131 and #132 in FIG. 7). If the ID is not registered in the traverser table TA2, there is no target person of extension who is crossing, so it is not necessary to elongate the display of the green signal. In this case, therefore, a notice of finishing the extension that means it is not necessary to elongate is sent to the signal equipment control portion 511 (steps #133 and #137 in FIG. 7). In contrast, if the ID is registered in the traverser table TA2, the switching time control portion 512 extracts the highest Level in the registered Levels (i.e., the Level having the highest necessity of extension), and it selects the extra time corresponding to the extracted Level with reference to the timer table TA1 (steps #133 and #134 in FIG. 7). Then, the selected extra time is set as a timer value of an extension timer (steps #135 and #136 in FIG. 7). Counting of the extension timer is started promptly. The timer value of this extension timer corresponds to the second set time of the present invention.

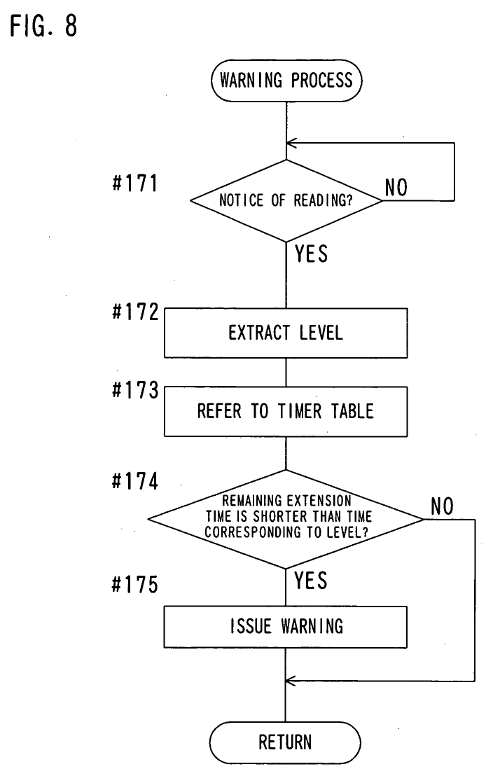

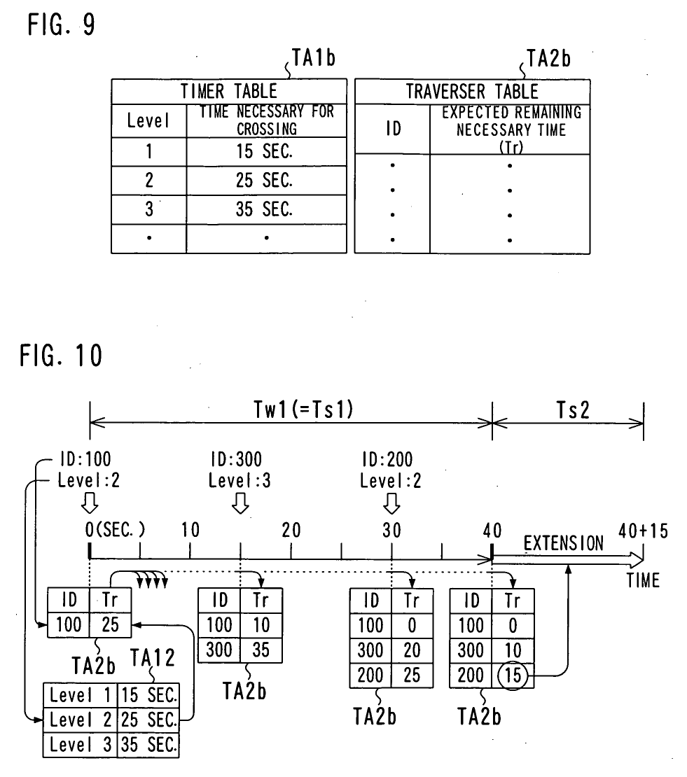

If there is a notice of reading during the extension timer is counted (step #5 in FIG. 4), the switching time control portion 512 gives a warning instruction to the traffic signal equipment 31 if necessary (step #6 in FIG. 4). The warning is necessary in the case where the crossing cannot be finished in the extension period of the green signal. An example of the process for determining whether the warning is necessary or not is shown in FIG. 8 (steps #171-175). The warning can be given to all the pedestrians by the audio output devices 212 and 222 or an electric light display. Otherwise, it can be given individually only to target persons of extension who has started crossing in the extra period. For example, there is a method of providing the transmitting devices 81 and 82 with a vibrating function or a sound generating function.

When the time count by the extension timer completes, the switching time control portion 512 sends a notice of finishing extension to the signal equipment control portion 511 (step #7). Responding to this, the signal equipment control portion 511 gives the instruction of inhibition of go to the traffic signal equipment 31 so as to switch the green signal to the blinking green signal and further to the red signal. After that, when the prescribed time passes, it gives the instruction of permission to go to the traffic signal equipment 21 so as to switch the red signal to the green signal.

In addition, when the extra time is finished, the switching time control portion 512 clears the traverser table TA2 (step #8). It is because the data that are stored at that time are not necessary for the signal control any more. There is a variation of a clearing method of the traverser table TA2, in which the clearing is postponed until the signal for pedestrians becomes the green signal next time or until an appropriate time point before that time point, and the registered data are kept during the signal for pedestrians is the red signal. According to this variation, if there is the notice of reading of the registered ID during the signal for pedestrians is the red signal, the ID can be stored separately as log information together with time or the like. The log information indicates that the pedestrian could not cross the road in the extra time of the green signal, and it can be used for reviewing the level information of the target person of extension and revaluation of the extra time of each level.

According to the embodiment explained above, the period of the green signal is elongated by a time corresponding to a walking speed Level of the target person of extension by using the timer table TA1 and the traverser table TA2. Therefore, excess or shortage of the extra time can be reduced compared with the case where the time is elongated uniformly, and a person who walks at the slowest speed and other people can cross safely.

Hereinafter, an embodiment will be explained in which more rational signal switching is realized.

FIG. 9 shows a variation of the table, and FIG. 10 shows an example of extra time setting by using the table shown in FIG. 9.

As shown in FIG. 9, the timer table TA1b organizes the relationship between the level information (Level) that indicates one of classes of walking speed divided into plural steps and a time necessary for crossing that is estimated for each class. In the illustrated example, Level 1 is related to 15 seconds, Level 2 is related to 25 seconds, and Level 3 is related to 35 seconds. The time necessary for crossing depends on the length of the crosswalk 10, so it is necessary to calculate the time necessary for crossing in accordance with the road to which the traffic signal system 1 is applied.

The traverser table TA2b stores an expected remaining necessary time (Tr) in relationship with the identification information (ID) received from the reader devices 41 and 42. The expected remaining necessary time (Tr) is a time period from the present time to the time point when the target person of extension is expected to finish crossing.

Using the timer table TA1b and the traverser table TA2b, extension without shortage can be realized as follows regardless of when the target person of extension started crossing.

In the example shown in FIG. 10, the prescribed time Tw1 of the green signal for pedestrians, i.e., the first set time Ts1 is 40 seconds.

It is supposed, for example, that a first target person of extension (ID: 100) of the Level 2 starts crossing at the same time as the red signal switches to the green signal. In this case, the time necessary for crossing (25 seconds) corresponding to Level 2 is read out of the timer table TA1b, and the time necessary for crossing is written into the traverser table TA2b as the expected remaining necessary time. In the traverser table TA2b, a value of the expected remaining necessary time is count down as time passes.

When 15 seconds have passed after switching to the green signal, it is supposed that a second target person of extension (ID: 300) of Level 3 starts crossing. The time necessary for crossing (35 seconds) corresponding to Level 3 is written together with the ID that is 300 into the traverser table TA2b. At this time point, the expected remaining necessary time corresponding to the first target person of extension has been updated to 10 (=25-15) seconds.

It is supposed that a third target person of extension (ID: 200) of Level 2 starts crossing when 30 seconds have passed from switching to the green signal. The time necessary for crossing (25 seconds) corresponding to Level 2 is written together with the ID that is 200 into the traverser table TA2b.

When the first set time Ts1 (40 seconds) has passed after switching to the green signal, the expected remaining necessary time corresponding to the first target person of extension has been updated to 0 seconds, the expected remaining necessary time corresponding to the second target person of extension has been updated to 10 seconds, and the expected remaining necessary time corresponding to the third target person of extension has been updated to 15 seconds. The longest time value of 15 seconds out of the updated three expected remaining necessary times is regarded as the second set time Ts2 that is the extra time of the green signal.

Thus according to this embodiment, rational signal switching control is performed so that a period of the green signal is elongated to meet the person who is the slowest traverser. As another variation, an upper limit (e.g., 20 seconds) for the extra time may be provided, and the upper limit is shorter than the longest expected crossing time (35 seconds in this example). In this case, it is necessary to set the time for permitting pedestrians to start the crossing shorter than the first set time Ts1, so that the target person of extension of the highest Level can complete the crossing before the green signal period that is elongated to the maximum. After a predetermined time has passed after switching to the green signal, the target person of extension who is expected to be not capable of crossing in the time period cannot be permitted to start crossing even if it is the green signal period. If such a target person of extension starts to cross, a warning is given to the target person.

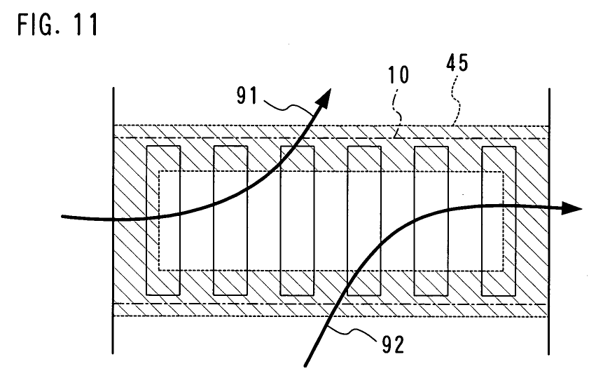

The hardware of the traffic signal system 1 can be also modified variously. FIG. 11 shows a variation of installing the reader device.

The reader device 45 shown in FIG. 11 has a ring-like shape that overlaps the crosswalk 10 at both ends in the length direction and at both ends in the width direction. According to the reader device 45, even if the person gets out of the crosswalk 10 during crossing as shown in an arrow 91 or enters the crosswalk 10 without passing the crosswalk 10 at the end in the length direction as shown in an arrow 92, i.e., even if pedestrians cross diagonally, the traffic signal equipment can be controlled in the same manner as the case where the crossing is performed correctly.

The present invention can be used for realizing smooth traffic by traffic signal equipment, and it particularly contributes to traffic safety in an aging society.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A controller device of traffic signal equipment for switch control of signals in accordance with an output signal of a traverser detecting device, comprising:
means for monitoring an input signal from the traverser detecting device, after switching a traffic signal displayed on the traffic signal equipment from a cross inhibition signal to a non cross inhibition signal;
means for displaying the non cross inhibition signal on the traffic signal equipment during a second time period before a second set time passes after a first time period ends when a detection signal that indicates a target person of extension is received from the traverser detecting device during the first time period, the first time period being before a first set time passes after switching from the cross inhibition signal to the non cross inhibition signal;
first switching means for switching the traffic signal displayed on the traffic signal equipment from the non cross inhibition signal to the cross inhibition signal responding to end of the second time period when a detection signal that indicates a target person of extension is received from the traverser detecting device during the first time period; and
second switching means for switching the traffic signal displayed on the traffic signal equipment from the non cross inhibition signal to the cross inhibition signal responding to end of the first time period when the detection signal is not received from the traverser detecting device during the first time period.

2. A controller device of traffic signal equipment for switch control of signals in accordance with an output signal of a traverser detecting device, comprising:
means for performing signal switch control for letting the traffic signal equipment display a first signal that indicates a cross inhibition, a second signal that indicates to be crossable and a third signal that indicates a cross inhibition period will come soon;
means for displaying the second signal on the traffic signal equipment during a second time period before a second set time passes after a first time period ends when a detection signal that indicates a target person of extension is received from the traverser detecting device during the first time period, the first time period being before a first set time passes after switching from the first signal to the second signal;
first switching means for switching the traffic signal displayed on the traffic signal equipment from the second signal to the third signal responding to end of the second time period when a detection signal that indicates a target person of extension is received from the traverser detecting device during the first time period; and
second switching means for switching the traffic signal displayed on the traffic signal equipment from the second signal to the third signal responding to end of the first time period when the detection signal is not received from the traverser detecting device during the first time period.

3. The controller device according to claim 2, further comprising
means for storing level information contained in the detection signal responding to the reception of the detection signal from the traverser detecting device in the first time period, and
means for setting time corresponding to the level information as the second set time.

4. The controller device according to claim 3, further comprising means for setting the longest time period among plural time periods corresponding to level information of plural detection signals as the second set time when the plural detection signals that respectively indicate plural target persons of extension are received from the traverser detecting device during the first time period.

5. The controller device according to claim 2, further comprising
means for storing identification information of the target person of extension and level information contained in the detection signal in connection with each other responding to the reception of the detection signal from the traverser detecting device during the first time period,
means for erasing the stored information about the identification information of the target person of extension and the corresponding level information when a detection signal containing the identification information of the target person of extension that is stored at the time is received from the traverser detecting device during the first time period, and
means for setting a time period corresponding to the level information stored at the time as the second set time after the first time period.

6. The controller device according to claim 2, further comprising means for giving a warning instruction to a warning device when a detection signal indicating a target person of extension is received from the traverser detecting device during the first time period and another detection signal indicating another target person of extension is received from the traverser detecting device during the second time period.

7. The controller device according to claim 6, further comprising means for giving a warning instruction to a warning device only in the case where a time period corresponding to the level information contained in the detection signal received during the second time period is longer than a remaining time period of the second time period when a detection signal indicating a target person of extension is received from the traverser detecting device during the first time period and another detection signal indicating another target person of extension is received from the traverser detecting device during the second time period.

8. The controller device according to claim 2, further comprising
means for storing time information that specifies a necessary extra time that is an additional portion of time corresponding to level information contained in the detection signal to the remaining time of the first set time at a reception time point responding to the reception of the detection signal from the traverser detecting device, and
means for setting a necessary extra time that is specified by the time information at the end of the first time period as the second set time.

9. The controller device according to claim 8, further comprising
means for storing time information that specifies a necessary extra time that is an additional portion of the time corresponding to the level information contained in the detection signal to the remaining time of the first set time at a reception time point for each reception when plural detection signals that respectively indicate plural target persons of extension are received from the traverser detecting device during the first time period, and
means for setting the longest time among the plural necessary extra time specified by the plural time information at the end of the first time period as the second set time.

10. A traffic signal system comprising:
traffic signal equipment installed at a crosswalk;
a traverser detecting device installed at the end in the crossing direction of the crosswalk;
a controller device for controlling the traffic signal equipment in accordance with an output signal of the traverser detecting device; and
a transmitting device carried by a target person of extension that is a specific pedestrian,
the traverser detecting device including
means for reading information contained in a signal from the transmitting device and transmits the information to the controller device, and
the controller device including
means for monitoring an input signal from the traverser detecting device, after switching a traffic signal displayed on the traffic signal equipment from a cross inhibition signal to a non cross inhibition signal,
means for displaying the non cross inhibition signal on the traffic signal equipment during a second time period before a second set time passes after a first time period ends when a detection signal that indicates a target person of extension is received from the traverser detecting device during the first time period, the first time period being before a first set time passes after switching from the cross inhibition signal to the non cross inhibition signal,
first switching means for switching the traffic signal displayed on the traffic signal equipment from the non cross inhibition signal to the cross inhibition signal responding to end of the second time period when a detection signal that indicates a target person of extension is received from the traverser detecting device during the first time period, and
second switching means for switching the traffic signal displayed on the traffic signal equipment from the non cross inhibition signal to the cross inhibition signal responding to end of the first time period when the detection signal is not received from the traverser detecting device during the period.

11. A traffic signal system comprising:
traffic signal equipment installed at a crosswalk;
a traverser detecting device installed at the end in the crossing direction of the crosswalk;
a controller device for controlling the traffic signal equipment in accordance with an output signal of the traverser detecting device; and
a transmitting device carried by a target person of extension that is a specific pedestrian,
the traverser detecting device including
means for reading information contained in a signal from the transmitting device and transmits the information to the controller device, and
the controller device including
means for performing signal switch control for letting the traffic signal equipment display a first signal that indicates a cross inhibition, a second signal that indicates to be crossable and a third signal that indicates a cross inhibition period will come soon,
means for displaying the second signal on the traffic signal equipment during a second time period before a second set time passes after a first time period ends when a detection signal that indicates a target person of extension is received from the traverser detecting device during the first time period, the first time period being before a first set time passes after switching from the first signal to the second signal,
first switching means for switching the traffic signal displayed on the traffic signal equipment from the second signal to the third signal responding to end of the second time period when a detection signal that indicates a target person of extension is received from the traverser detecting device during the first time period, and
second switching means for switching the traffic signal displayed on the traffic signal equipment from the second signal to the third signal responding to end of the first time period when the detection signal is not received from the traverser detecting device during the first time period.

12. The traffic signal system according to claim 11, comprising plural traverser detecting devices installed at one end and at the other end in the crossing direction of the crosswalk,
the transmitting device including means for storing identification information of the target person of extension and level information so that the traverser detecting device can read the information,
the controller device including means for storing identification information of the target person of extension and level information contained in the detection signal in connection with each other responding to the reception of the detection signal from the traverser detecting device during the first time period,
means for erasing the stored information about the identification information of the target person of extension and the corresponding level information when a detection signal containing the identification information of the target person of extension that is stored at the time is received from the traverser detecting device during the first time period, and
means for setting a time period corresponding to the level information stored at the time as the second set time after the first time period.

13. The traffic signal system according to claim 12, comprising plural traverser detecting devices installed at one end and at the other end in the crossing direction of the crosswalk,
the controller device including means for receiving an input signal from each of the plural traverser detecting devices.

14. A computer program product for use in a computer that performs signal switching for traffic signal equipment in accordance with an output signal of a traverser detecting device, the computer program product making the computer execute the process comprising the steps of:
switching a traffic signal displayed on the traffic signal equipment from a cross inhibition signal to a non cross inhibition signal;
letting the traffic signal equipment display the non cross inhibition signal during a second time period before a second set time passes after a first time period ends when a detection signal that indicates a target person of extension is received from the traverser detecting device during the first time period, the first time period being before a first set time passes after switching from the cross inhibition signal to the non cross inhibition signal;
switching the traffic signal displayed on the traffic signal equipment from the non cross inhibition signal to the cross inhibition signal responding to end of the second time period when a detection signal that indicates a target person of extension is received from the traverser detecting device during the first time period; and
switching the traffic signal displayed on the traffic signal equipment from the non cross inhibition signal to the cross inhibition signal responding to end of the first time period when the detection signal is not received from the traverser detecting device during the time period.

15. A computer program product for use in a computer that controls traffic signal equipment to display a first signal that indicates a cross inhibition, a second signal that indicates to be crossable and a third signal that indicates the cross inhibition period will come soon, the computer program product making the computer execute the process comprising the steps of:
letting the traffic signal equipment display the second signal during a second time period before a second set time passes after a first time period ends when a detection signal that indicates a target person of extension is received from the traverser detecting device during the first time period, the first time period being before a first set time passes after switching from the first signal to the second signal;
switching the traffic signal displayed on the traffic signal equipment from the second signal to the third signal responding to end of the second time period when a detection signal that indicates a target person of extension is received from the traverser detecting device during the first time period; and
switching the traffic signal displayed on the traffic signal equipment from the second signal to the third signal responding to end of the first time period when the detection signal is not received from the traverser detecting device during the first time period.

16. A computer readable recording medium on which a computer program is recorded for making the computer execute the process comprising the steps of:
switching a traffic signal displayed on the traffic signal equipment from a cross inhibition signal to a non cross inhibition signal;
letting the traffic signal equipment display the non cross inhibition signal during a second time period before a second set time passes after a first time period ends when a detection signal that indicates a target person of extension is received from the traverser detecting device during the first time period, the first time period being before a first set time passes after switching from the cross inhibition signal to the non cross inhibition signal;
switching the traffic signal displayed on the traffic signal equipment from the non cross inhibition signal to the cross inhibition signal responding to end of the second time period when a detection signal that indicates a target person of extension is received from the traverser detecting device during the first time period; and
switching the traffic signal displayed on the traffic signal equipment from the non cross inhibition signal to the cross inhibition signal responding to end of the first time period when the detection signal is not received from the traverser detecting device during the time period.

17. A computer readable recording medium on which a computer program is recorded for making the computer execute the process comprising the steps of:
letting the traffic signal equipment display the second signal during a second time period before a second set time passes after a first time period ends when a detection signal that indicates a target person of extension is received from the traverser detecting device during the first time period, the first time period being before a first set time passes after switching from the first signal to the second signal;
switching the traffic signal displayed on the traffic signal equipment from the second signal to the third signal responding to end of the second time period when a detection signal that indicates a target person of extension is received from the traverser detecting device during the first time period; and
switching the traffic signal displayed on the traffic signal equipment from the second signal to the third signal responding to end of the first time period when the detection signal is not received from the traverser detecting device during the first time period.
